(19) United States
(12) Patent Application Publication
(10) Pub. No.: US 2026/0328698 A1
(43) Pub. Date: Oct. 22, 2026

(54) Lighting Optical Device and Inspection Device

(71) Applicant: Hitachi High-Tech Corporation, Minato-ku, Tokyo (JP)

(72) Inventors: Masanori TAMURA, Tokyo (JP); Akihiro IWAMATSU, Tokyo (JP); Shunichi MATSUMOTO, Tokyo (JP)

(21) Appl. No.: 19/113,165

(22) PCT Filed: Sep. 21, 2022
(86) PCT No.: PCT/JP2022/035197

§ 371 Date: Mar. 19, 2025

(51) Int. Cl. G01N 21/88; G01N 21/95

(52) U.S. Cl. CPC G01N 21/8806; G01N 21/9501

(57) ABSTRACT

In substrate inspection devices, the size of defects and foreign matter which need to be detected has decreased, and use of a high-power deep ultraviolet laser light source to form a beam spot with high precision has increased detection sensitivity. Thus, there is a need to further increase the stability of size and position of a beam spot. Furthermore, it is important that variations in focus position are not caused when there is a change in ambient temperature during device operation. To this end, provided is a lighting optical system that flexibly changes the beam spot diameter of lighting light in accordance with inspection conditions and stage movement, while also maintaining high-precision focus performance which can handle changes in ambient temperature. More specifically, suppression of variations in focus position is made possible by optimizing the arrangement and materials of an optical element of a transparent optical system constituting a device (see FIG. 1).

### TECHNICAL FIELD

The present invention relates to a lighting optical device and an inspection device.

### BACKGROUND ART

A lighting optical system and a substrate inspection device are used to detect foreign matter on an inspection target by irradiating the surface of the inspection target with light and detecting reflected or scattered light from the inspection target.

In a manufacturing line for a semiconductor substrate and a thin-film substrate, defects on the surfaces of the semiconductor substrate and the thin-film substrate are inspected to maintain or improve product yields. The defects can be inspected using an inspection device.

Regarding a lighting optical device used in an inspection device, PTL 1 discloses that a condensing optical system equipped with a cylindrical parabolic mirror and a condenser lens is used to control a beam spot in the longitudinal direction, in order to flexibly change a beam spot diameter in the longitudinal direction in accordance with inspection conditions and a stage operation while maintaining the focus of the beam spot.

### CITATION LIST

### Patent Literature

PTL 1: WO2021/205650A

### SUMMARY OF INVENTION

### Technical Problem

However, the technology disclosed in PTL 1 does not take into consideration a positional deviation of a beam spot due to changes in ambient temperature.

In addition, due to recent technological innovations, the sizes of defects and foreign matter that need to be detected are becoming smaller. For this reason, detection sensitivity is improved by forming beam spots with high precision using high-output deep ultraviolet laser light sources. In order to increase detection sensitivity, there is a demand for even higher stability in the sizes and positions of the beam spots. Thus, it is possible to obtain highly accurate inspection results when coping with a positional deviation of a beam spot due to changes in ambient temperature.

Due to demands for higher output, shorter wavelengths, and higher stability of a beam spot position of a light source based on the demand for higher sensitivity in defect detection as described above, measures for improving the focusing performance of a beam spot in a wavelength region (for example, a deep ultraviolet region) of illumination light have been required.

In view of this situation, the present disclosure provides a lighting optical system that maintains high-precision focusing performance coping with changes in ambient temperature while flexibly changing a beam spot diameter of illumination light in accordance with inspection conditions and a stage operation, and a substrate inspection device including the lighting optical system.

### Solution to Problem

In order to solve the above problems, the present disclosure provides a lighting optical device that expands a luminous flux and condenses it on a target, the lighting optical device including a light source that emits the luminous flux, a luminous flux diameter variable unit that expands a diameter of the luminous flux emitted from the light source, and a condensing optical system that condenses the luminous flux having the expanded diameter on the target, in which the luminous flux diameter variable unit includes at least four lenses, at least one lens of the luminous flux diameter variable unit satisfies Conditional Expression (1), at least one lens of the luminous flux diameter variable unit other than the lens satisfying Conditional Expression (1) satisfies Conditional Expression (2), the condensing optical system includes at least two lenses, at least two lenses of the condensing optical system satisfy Conditional Expression (3), at least one lens of the condensing optical system satisfies Conditional Expression (1), and at least one lens of the condensing optical system other than the lens satisfying Conditional Expression (1) satisfies Conditional Expression (2).

$$dn / dt < 0 \qquad ( 1 )$$

$$dn / dt > 0 \qquad ( 2 )$$

$$\vert \begin{matrix}{\sum }_{i = 1}^{m} ( {f}_{i} * \frac{d {n}_{i}}{dt} ) \vert < \vert f * \frac{MAX\_dn}{dt} \vert & ( 3 ) )\end{matrix}$$

Here, dn/dt represents a temperature coefficient of a refractive index, m represents the number of lenses provided in the condensing optical system, fi represents a focal length of an i-th lens in the condensing optical system, dnᵢ/dt represents a refractive index temperature coefficient of the i-th lens in the condensing optical system, f represents a focal length of the condensing optical system, and MAX_dnᵢ/dt represents a maximum value of absolute values of the refractive index temperature coefficients of the lenses provided in the condensing optical system.

Further features related to the present disclosure become apparent from the description in this specification and the accompanying drawings. In addition, aspects of the present disclosure are achieved and implemented by elements, combinations of various elements, and aspects of the following detailed description and the appended claims.

The description in this specification is merely a typical example and does not limit the scope of the claims or application examples of the present disclosure in any sense.

### Advantageous Effects of Invention

According to the technology of the present disclosure, it is possible to maintain high-precision focusing performance even when a temperature changes.

### BRIEF DESCRIPTION OF DRAWINGS

FIG. 1 is a diagram showing a configuration example of a lighting optical system OP1 according to a first embodiment of the present disclosure.

FIG. 2 is a diagram showing an example of a schematic internal configuration of a luminous flux diameter variable unit 4 according to the present disclosure.

FIG. 3 is a diagram showing an example of a schematic configuration of a condensing optical system 5 according to the first embodiment.

FIG. 4 is a diagram showing a configuration example of a support structure 6.

FIG. 5 is a diagram showing an example of a schematic configuration of a substrate inspection device 100.

FIG. 6 is a diagram showing a configuration example of a lighting optical system OP1 according to a second embodiment.

FIG. 7 is a diagram showing an example of the arrangement of two spherical lenses 25c and 25d in a condensing optical system 25.

### DESCRIPTION OF EMBODIMENTS

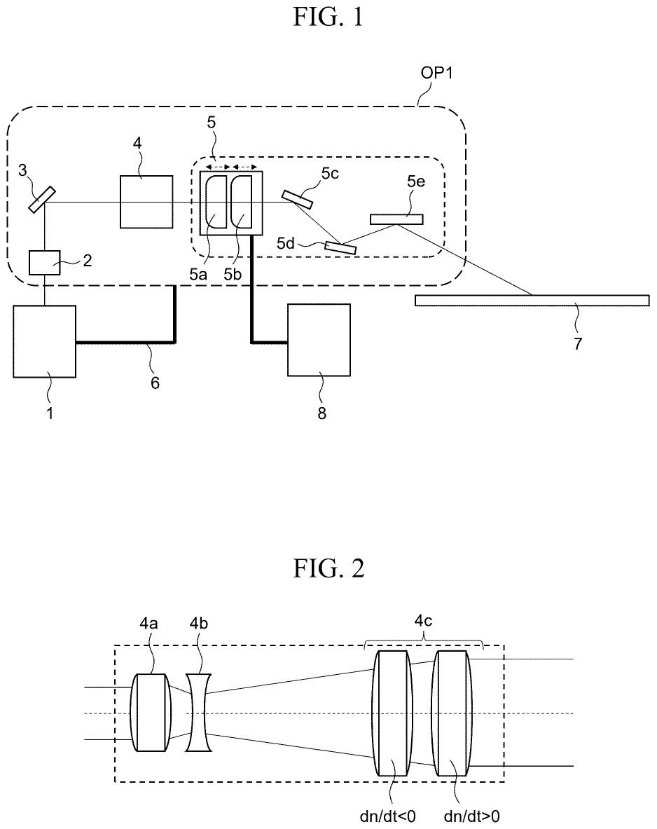

The temperature near a lighting optical system (near a component shown in FIG. 1) frequently changes due to heat of a motor that is used for a high output of a light source based on high sensitivity of defect detection and used for driving of a high-speed rotating stage and the like, and other motors that are used to adjust the amount of light and an optical axis. However, it is necessary to maintain high-sensitivity defect detection even when the temperature changes, and for this purpose, it is extremely important to maintain the focus performance of a beam spot formed on a wafer.

Embodiments of the present disclosure propose technology that makes it possible to maintain the focus performance of a beam spot formed on a wafer. Hereinafter, the embodiments of the present invention will be described based on the accompanying drawings.

### (1) First Embodiment

### Configuration Example of Lighting Optical System

FIG. 1 is a diagram showing a configuration example of a lighting optical system OP1 according to a first embodiment of the present disclosure. The lighting optical system OP1 includes a DUV light source (deep ultraviolet light source, wavelength range of 200 to 300 nm) 1, an attenuator 2, a mirror 3, a luminous flux diameter variable unit (expander) 4, a condensing optical system 5, a support structure 6, and a control unit 8 (the control unit 8 may be provided outside the lighting optical system OP1).

The DUV light source 1 emits parallel light (which may be referred to as linear light). In FIG. 1, parallel light is schematically shown as a straight line. Further, in this embodiment, the DUV light source 1 is used as a light source. However, this is not limiting, and any light source that emits light of any wavelength can be used.

The support structure 6 has a structure in which a group of elements (such as the attenuator 2, the mirror 3, the luminous flux diameter variable unit 4, and the condensing optical system 5) for guiding light from the DUV light source 1 to an inspection target 7 can be fixed. The support structure 6 may be configured with a single fixing member or supporting member, or may be a mechanical structure in which a plurality of members are combined. The control unit 8 can change the position on the optical axis of cylindrical lenses 5a and 5b of the condensing optical system 5 supported by the support structure 6 (move them on the optical axis) in response to an instruction input by a user, for example.

For example, the amount of light emitted from the DUV light source 1 is adjusted by the attenuator 2. The light of which the amount has been adjusted is reflected by the mirror 3, the moving direction of the light is changed, and the light is guided to the luminous flux diameter variable unit 4. The luminous flux diameter variable unit 4 expands the luminous flux diameter of the light reflected by the mirror 3 and guides it to the condensing optical system 5. The condensing optical system 5 condenses the light of which the luminous flux diameter has been expanded, and emits the condensed light onto the inspection target 7.

In the lighting optical system OP1 shown in FIG. 1, the internal configuration of the luminous flux diameter variable unit 4 and the internal configuration of the condensing optical system 5 are devised to maintain focus performance even when the temperature changes.

### Example of Internal Configuration of Luminous Flux Diameter Variable Unit 4

FIG. 2 is a diagram showing an example of a schematic internal configuration of the luminous flux diameter variable unit 4 according to this embodiment. The luminous flux diameter variable unit 4 includes a positive lens group (at least one positive lens) 4a, a negative lens group (at least one negative lens) 4b, and a positive lens group (configured with two positive lenses) 4c (configured with at least four lenses).

The positive lens group 4a is arranged on the DUV light source 1 side, and the positive lens group 4c is arranged on the inspection target 7 side. Parallel light is incident on the luminous flux diameter variable unit 4, and the light emitted from it is also parallel light. However, the light is emitted with a luminous flux diameter that is expanded with respect to the incident luminous flux diameter. The luminous flux diameter variable unit 4 is configured such that any one of the groups that configure the luminous flux diameter variable unit 4 or all the groups can move in the optical axis direction, and thus the emitted luminous flux diameter can be changed.

When at least two lenses provided in the positive lens group 4c are formed of materials having refractive index temperature coefficients (dn/dt) of the same sign, the refractive index becomes higher (lower) due to temperature changes, and luminous flux emitted from the luminous flux diameter variable unit 4 converges (diverges). However, in order to condense light generated from the light source 1 on a wafer (inspection target 7), the luminous flux emitted from the luminous flux diameter variable unit 4 needs to be parallel light.

On the other hand, when at least two lenses provided in the positive lens group 4c are formed of materials having refractive index temperature coefficients (dn/dt) of different signs, the refractive power of a lens having a refractive index temperature coefficient shown in Expression (1) increases when the ambient temperature rises. However, the refractive power of the other lens having a refractive index temperature coefficient shown in Expression (2) decreases, and thus it is possible to reduce a defocus change (cancel at least a part) when the temperature rises. As a result, it is possible to make the light emitted from the luminous flux diameter variable unit 4 substantially parallel even when the ambient temperature changes.

dn/dt>0 (1)

dn/dt<0 (2)

An example of a combination of materials having refractive index temperature coefficients (dn/dt) of different signs may be synthetic quartz (dn/dt>0) and fluorite (dn/dt<0). When synthetic quartz (dn/dt>0) or fluorite (dn/dt<0) is used as the materials of the lenses that configure the luminous flux diameter variable unit 4, it is possible to curb a focus shift when the ambient temperature changes due to the above-mentioned reason.

In the case of the configuration shown in FIG. 2, for example, the positive lens group 4a and the negative lens group 4b are formed of synthetic quartz, one of the two positive lenses provided in the lens group 4c is formed of synthetic quartz, and the other is formed of fluorite, it is possible to curb focus fluctuations that occur when the ambient temperature changes as described above. The same effect can be expected when the positive lens group 4a and the negative lens group 4b are formed of fluorite, one of the two positive lenses provided in the lens group 4c is formed of quartz, and the other is formed of fluorite.

### Configuration Example of Condensing Optical System 5

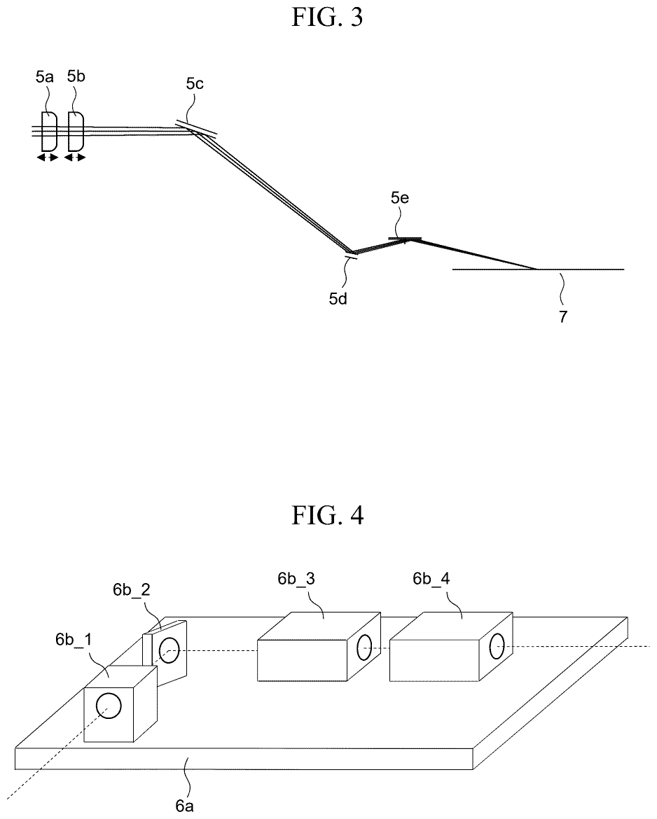

FIG. 3 is a diagram showing an example of a schematic configuration of the condensing optical system 5. The condensing optical system 5 includes at least two cylindrical lenses 5a and 5b, two return mirrors 5c and 5d, and one cylindrical parabolic mirror 5e, in that order from the luminous flux diameter variable unit 4 side (light incident side). Depending on a light irradiation angle with respect to the inspection target 7, the mirrors 5c and 5d are not essential components.

The parallel light from the luminous flux diameter variable unit 4 is condensed on the inspection target 7 by the cylindrical lenses 5a and 5b and the cylindrical parabolic mirror 5e. The light condensed by the cylindrical lenses 5a and 5b are luminous flux in the up-down direction of the paper in FIG. 3. The luminous flux in the depth direction on the paper is condensed on the inspection target 7 by the cylindrical parabolic mirror 5e.

The amount of focus fluctuation (change in focal position) due to a temperature change can be estimated from the product of the refractive power of the lens (=the reciprocal of the focal length) and the refractive index temperature coefficient (dn/dt). When the sum of the products of the focal lengths and the refractive index temperature coefficients of the lenses that configure the optical system is small, the focus fluctuation is also small. Thus, it is important to satisfy the following formula.

$$\vert \begin{matrix}{\sum }_{i = 1}^{m} ( {f}_{i} * \frac{d {n}_{i}}{dt} ) \vert < \vert f * \frac{MAX\_dn}{dt} \vert & ( 3 ) )\end{matrix}$$

Here, characters or character expressions indicate:
m: the number of lenses provided in the condensing optical system;
fi: a focal length of an i-th lens in the condensing optical system;
dnᵢ/dt: a refractive index temperature coefficient of the i-th lens in the condensing optical system;
f: a focal length of the condensing optical system;
MAX_dnᵢ/dt: a maximum absolute value of the refractive index temperature coefficients of the lenses provided in the condensing optical system.

The right side in Expression (3) shows the amount of focus fluctuation when the condensing optical system 5 is configured with lenses of a single material. When the left side in Expression (3) is smaller than the right side, it means that the optical system has reduced focus fluctuation when the temperature changes.

When the two cylindrical lenses 5a and 5b are formed of the same glass material (same optical glass) and have different power (refractive power) signs, Expression (3) can be satisfied. For this reason, it is possible to achieve an optical system with a small focus fluctuation. Here, a case is considered in which the power of the cylindrical lens 5a is positive (convex lens), the power of the cylindrical lens 5b is negative (concave lens), both glass materials are fluorite, and the ambient temperature rises. In this case, the refractive power of the cylindrical lens 5a decreases due to the temperature rise, but the refractive power of the cylindrical lens 5b increases, and thus the overall refractive power fluctuation can be canceled (at least partially canceled). As a result, it is possible to curb focus fluctuations on the inspection target 7.

Furthermore, it is possible to enhance the effect of curbing focus fluctuations by optimizing the focal length of each lens so that the left side in Expression (3) becomes extremely small. In addition, arranging two cylindrical lenses so that their surfaces having power face each other is suitable for aberration correction. For example, during inspection (while the condensing optical system 5 is in use), the focal length can be optimized by moving the cylindrical lens 5a and/or 5b on the optical axis. For example, an image of a beam spot size on the inspection target (for example, a wafer) 7 is captured by a camera (not shown), and a user confirms it. Then, in response to the user's instruction, the control unit 8 can appropriately adjust the beam spot size by moving the cylindrical lens 5a and/or 5b on the optical axis. In addition, by using a low expansion metal (for example, Invar) as the material forming the support structure 6 that holds the optical elements including the cylindrical lenses 5a and 5b and the cylindrical parabolic mirror 5e, it is possible to further improve the focusing performance when the temperature changes.

The focal lengths of the cylindrical lenses 5a and 5b and the cylindrical parabolic mirror 5e are each optimized such that light is condensed on the inspection target 7. In addition, the cylindrical lenses 5a and 5b and the cylindrical parabolic mirror 5e are configured such that a beam spot diameter on the inspection target 7 can be formed linearly (linear: a beam spot shape is an elliptical shape of which the major axis is significantly larger than the minor axis) by making the focal lengths of the lenses different from each other. The reason for making it linear (elliptical) is to increase a scan width and a throughput when performing beam scanning while rotating and moving a stage (not shown) on which the inspection target 7 (wafer) is placed.

Assuming that the composite focal length of the cylindrical lenses 5a and 5b is fA, the focal length of the cylindrical parabolic mirror 5e is fB, an elevation angle of a light beam incident on the inspection target 7 is 0, the wavelength of the DUV light source 1 is 2, the diameter of a beam (luminous flux) incident on the condensing optical system 5 in the longitudinal direction is DA, and the diameter of the beam in the transverse direction is DB, a relationship between a beam diameter DA formed on the inspection target 7 in the right-left direction in FIG. 3 and a beam diameter QB formed in the depth direction is expressed by the following Formulas (4) and (5).

φA=1.22*fA*λ/(DA*sinθ) (4)

φB=1.22*fB*λ/(DA*sinθ) (5)

Thus, it can be seen that a beam spot diameter and a beam aspect ratio can be controlled by adjusting the diameter of luminous flux (DA and DB) incident on the condensing optical system 5, the composite focal length of the cylindrical lenses 5a and 5b, and the focal length of the cylindrical parabolic mirror 5e. In this embodiment, the composite focal length of the cylindrical lenses 5a and 5b is longer than the focal length of the cylindrical parabolic mirror 5e, and thus the major axis is formed in the right-left direction of the paper and the minor axis is formed in the depth direction of the paper on the inspection target 7.

As described above, either or both of the cylindrical lenses 5a and 5b are moved in the optical axis direction, and thus a focal length corresponding to the longitudinal side of a beam spot can be changed. For this reason, it is possible to control the aspect ratio of the beam spot emitted to the inspection target 7. As described above, the control unit 8 can move the positions of the cylindrical lenses 5a and/or 5b on the optical axis by controlling a lens drive unit (the lens drive unit itself is not shown in the drawing) that moves the cylindrical lenses 5a and 5b in response to an instruction input by the user.

In the case of a substrate inspection device that detects foreign matter by operating a single inspection target, when a beam spot diameter in the longitudinal direction is made larger, a smaller number of times of scanning is required, making it possible to inspect the entire surface of the inspection target in a shorter time. On the other hand, the positioning accuracy of foreign matter deteriorates. For this reason, it is desirable that a beam spot diameter can be changed in the longitudinal direction in accordance with the material and size of an inspection target, an inspection speed, and the like in one lighting optical system.

With the configuration shown in FIG. 3, it is possible to implement the lighting optical system OP1 in which an aspect ratio of a beam spot is controlled and a focus shift is curbed when the ambient temperature changes.

### Configuration Example of Support Structure 6

FIG. 4 is a diagram showing a configuration example of the support structure 6. The support structure 6 can be configured with, for example, a base 6a and element support members 6b_1 to 6b_4. The support structure 6 may be configured with a plurality of elements fixed on the same base 6a, or may be configured with a plurality of bases.

In addition, the element support members 6b_1 to 6b_4 may be configured with a single member, or may be a mechanical structure configured with a combination of a plurality of members.

### Configuration Example of Substrate Inspection Device

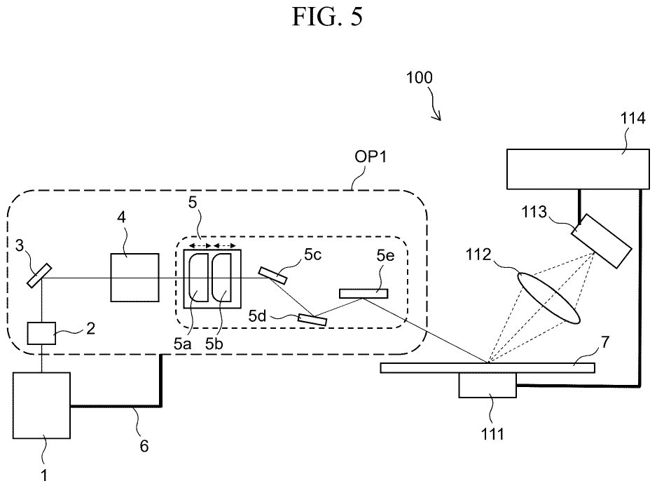

FIG. 5 is a diagram showing an example of a schematic configuration of the substrate inspection device 100. The substrate inspection device 100 shown in FIG. 5 may be equipped with the lighting optical system OP1 according to the first embodiment, but may be equipped with a lighting optical system OP2 according to a second embodiment to be described later instead.

The substrate inspection device 100 includes a lighting optical system OP1, a stage 111 on which the inspection target 7 is placed, a light receiving lens 112, a light receiving element 113, and an analysis unit 114.

In the substrate inspection device 100, the inspection target 7 is fixed on the stage 111. The stage 111 can rotate around a rotation axis in the vertical direction of the paper in FIG. 5, and can also move in parallel in a direction perpendicular to the rotation axis (for example, the right-left direction of the paper in FIG. 5). In the configuration example, the longitudinal direction of a linear beam spot formed by the lighting optical system OP1 also coincides with this.

In addition, the inspection target 7 has a disk shape (for example, a wafer) and can be moved in parallel while rotating by the stage 111. Thereby, it is possible to irradiate the entire surface of the disk (inspection target 7) with light.

The light receiving lens 112 condenses a part of diffused and reflected light generated when a defect or foreign matter on the inspection target 7 is hit by light. The light receiving element 113 converts the light condensed by the light receiving lens 112 into an electrical signal. The analysis unit 114 receives the electrical signal from the light receiving element 113 and analyzes it. The analysis unit 114 also takes an analysis result as an inspection result and outputs it, for example, on a display screen of a display device (not shown). For this reason, the analysis unit 114 may be equipped with a computer.

In this manner, the substrate inspection device 100 inspects the inspection target 7 (foreign matter inspection, defect inspection). Here, as described above, a light beam output by the lighting optical system OP1 is condensed in a linear shape with high precision, and thus more precise inspection can be performed.

In addition to a signal analysis function, the analysis unit 114 may also have a function of appropriately arranging optical elements (for example, a condensing optical system or a luminous flux diameter variable unit) arranged on the optical path (it may also have the function of the control unit 8 in FIG. 1). This function may be performed in accordance with a user input for the substrate inspection device 100 or may be performed automatically by the analysis unit 114. When the analysis unit 114 automatically controls the arrangement of the optical elements, the optical elements may be selected such that an electrical signal obtained by the light receiving element 113 is set to be in an optimal state for a target inspection. Although FIG. 5 shows one light receiving lens 112 and one light receiving element 113, the number of either one or both of them provided may be plural.

### (2) Second Embodiment

### Configuration Example of Lighting Optical System

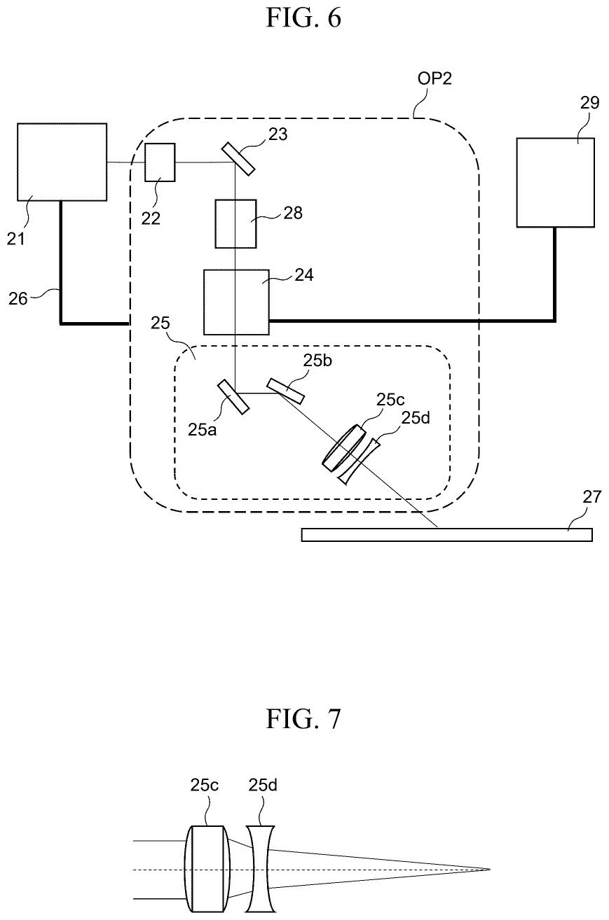

FIG. 6 is a diagram showing a configuration example of a lighting optical system OP1 according to a second embodiment. The lighting optical system OP2 according to the second embodiment is configured such that the condensing optical system 5 is configured with an axisymmetric spherical lens instead of a cylindrical lens as compared to the lighting optical system OP1 according to the first embodiment.

That is, in the first embodiment, the cylindrical lenses 5a and 5b condense light in the right-left direction of the paper, and the cylindrical parabolic mirror 5e condenses light in the depth direction of the paper. In addition, an aspect ratio of a beam spot is controlled by making the focal lengths of the cylindrical lenses 5a and 5b and the cylindrical parabolic mirror 5e different from each other.

On the other hand, as shown in FIG. 6, the lighting optical system OP2 according to the second embodiment includes a DUV light source (deep ultraviolet light source) 21, an attenuator 22, a mirror 23, an anamorphic prism 28, a luminous flux diameter variable unit (expander) 24, a condensing optical system 25, a support structure 26, and a control unit 29 (the control unit 29 may be provided outside the lighting optical system OP2). In the second embodiment, in the condensing optical system 25, axisymmetric spherical lenses 25c and 25d are both responsible for image formation in both the right-left direction and the depth direction of the paper instead of the cylindrical lenses 5a and 5b in the first embodiment. In addition, an anamorphic prism 28 is provided on the optical path to control an aspect ratio of a beam spot.

The condensing optical system 25 includes two mirrors 25a and 25b and two spherical lenses 25c and 25d in order when viewed from the DUV light source 21 side. Even when the condensing optical system 25 is configured with an axisymmetric spherical lens, it is possible to curb a focus shift due to changes in ambient temperature by satisfying the condition shown in the above Expression (3).

FIG. 7 is a diagram showing an example of the arrangement of the two spherical lenses 25c and 25d in the condensing optical system 25. In the condensing optical system 25, when one of the two spherical lenses 25c and 25d is formed of synthetic quartz and the other is formed of fluorite, the condition shown in Expression (3) can be satisfied. Thus, as in the first embodiment, it is possible to implement the condensing optical system 25 that curbs a focus fluctuation. Considering a case where the spherical lens 25c is formed of synthetic quartz and the spherical lens 25d is formed of fluorite, and the ambient temperature rises, the refractive power of 5c increases due to the temperature rise, but the refractive power of 5d decreases. Thus, the overall refractive power fluctuation can be canceled (at least partially canceled). As a result, it is possible to curb a focus fluctuation on the inspection target 7.

A circular luminous flux from the DUV light source 21 becomes elliptical after passing through the anamorphic prism 28. In the example shown in FIG. 6, the longitudinal direction of the elliptical beam emitted from the anamorphic prism 28 corresponds to the depth direction of the paper, and the transverse direction corresponds to the right-left direction on the page. A pupil diameter D of the beam before being incident on the condensing optical system 25 is smaller in the right-left direction of the paper (DB) than in the depth direction of the paper (DA). Since beam diameters φA and ΩB on the inspection target 27 are as given by the above Formulas (4) and (5), a linear (elliptical) beam spot is formed on the inspection target 27. Here, the long side of the beam spot corresponds to the right-left direction of the paper, and the short side corresponds to the depth direction of the paper.

In addition, the luminous flux diameter variable unit 24, which is arranged downstream of the anamorphic prism 28, can change the size of the elliptical beam by the control unit 29 controlling an internal optical element to move in the optical axis direction (a lens driving unit (not shown) moving the optical element in response to a control signal from the control unit 29).

Furthermore, it is possible to enhance the effect of curbing a focus fluctuation by optimizing the focal length of each of the spherical lenses 25c and 25d so that the left side in Expression (3) becomes extremely small (a difference in refractive index temperature coefficient between synthetic quartz and fluorite is canceled). Here, the condensing optical system 25 is configured with two lenses, but there is no limit to the number of lenses as long as Expression (3) is satisfied.

### (3) Others

### (i) Conditions for Lens Interval in Condensing Optical System

In the condensing optical system 5 or 25, regarding two lens intervals (DR: a distance between the cylindrical lenses 5a and 5b, or a distance between the spherical lenses 25c and 25d), when the largest interval between optical elements among the intervals between the optical elements provided in the condensing optical system 5 or 25 (an interval between the cylindrical lens 5a and the cylindrical parabolic mirror 5e in the condensing optical system 5) is assumed to be DR_max, and DR is set to be less than 1/10 of DR_max (DR<DR_max/10), a focus fluctuation can be curbed more efficiently.

### (ii) Conditions for Focal Lengths of Lenses in Light Beam Diameter Variable Unit 4 and Condensing Optical System 5 or 25

When the lenses provided in the luminous flux diameter variable unit 4 and the light collecting optical system 5 or 25 satisfy the above Formulas (1) and (2), the lenses may be configured to further satisfy Expression (6).

|f_max|−|f_min|<50 mm (6)

Here, f_max represents a focal length of a lens with the longest focal length, and f_min represents a focal length of a lens with the shortest focal length.

### (4) Summary

(i) The lighting optical device according to this embodiment includes the luminous flux diameter variable unit (expander) 4 or 24 and the condensing optical system 5 or 25. In the luminous flux diameter variable unit, at least one lens is configured to satisfy dn/dt<0 (Conditional Expression (1)), and at least one other lens is configured to satisfy dn/dt>0 (Conditional Expression (2)). At least two lenses in the condensing optical system are configured to satisfy Conditional Expression (3). In addition, at least one lens in the condensing optical system is configured to satisfy Conditional Expression (1), and at least one other lens is configured to satisfy Conditional Expression (2).

$$\vert \begin{matrix}{\sum }_{i = 1}^{m} ( {f}_{i} * \frac{d {n}_{i}}{dt} ) \vert < \vert f * \frac{MAX\_dn}{dt} \vert & ( 3 ) )\end{matrix}$$

Here, dn/dt represents a temperature coefficient of a refractive index, m represents the number of lenses provided in the condensing optical system, fi represents a focal length of an i-th lens in the condensing optical system, dnᵢ/dt represents a refractive index temperature coefficient of the i-th lens in the condensing optical system, f represents a focal length of the condensing optical system, and MAX_dnᵢ/dt represents the maximum value of absolute values of the refractive index temperature coefficients of the lenses provided in the condensing optical system. By configuring the lighting optical device in this manner, it is possible to maintain the focusing performance of the illumination light with high precision even when the ambient temperature changes. In the lighting optical device, a light source that emits linear light and has a wavelength range of 200 nm to 300 nm can be used. When the linear light is used, it becomes easier to control an aspect ratio of a beam spot of light emitted to an inspection target. In addition, when beam spots with different aspect ratios are used, it is possible to increase the throughput when inspecting the inspection target.
(ii) When DR is a distance between two lenses provided in the condensing optical system, and DR_max is the largest interval between optical elements among the intervals between the optical elements provided in the condensing optical system, the condensing optical system 5 or 25 may be configured to satisfy DR<DR_max/10. In this manner, a beam spot diameter on the inspection target can be flexibly changed in accordance with inspection conditions and a stage operation.
(iii) The two lenses provided in the condensing optical system 5 according to the first embodiment are cylindrical lenses arranged such that their power directions face each other. The two lenses provided in the condensing optical system 25 according to the second embodiment are spherical lenses arranged such that their power directions face each other. In this manner, a beam spot diameter on the inspection target can be flexibly changed in accordance with inspection conditions and a stage operation.
(iv) When f_max is assumed to be a focal length of a lens with the longest focal length among the lenses, and f_max is assumed to be a focal length of a lens with the shortest focal length among the lenses, a lens that is provided in the luminous flux diameter variable unit 4 or 24 and the condensing optical system 5 or 25 and satisfies the above-mentioned dn/dt<0 (Conditional Expression (1)) and dn/dt>0 (Conditional Expression (2)) can be configured to satisfy |f_max|−|f_min|<50 mm. In this manner, a beam spot diameter on the inspection target can be flexibly changed in accordance with inspection conditions and a stage operation.
(v) The lighting optical device according to the second embodiment includes the control unit 29 that moves at least one lens provided in the luminous flux diameter variable unit 24 in the optical axis direction. The control unit 29 increases or decreases a luminous flux diameter and controls a beam diameter by moving at least one lens of the luminous flux diameter variable unit 24 in the optical axis direction. In this manner, it is possible to flexibly adjust a beam spot diameter.
(vi) The support structure 6 holds at least the luminous flux diameter variable unit 4 or 24 and the condensing optical system 5 or 25. The support structure can be formed of a low expansion metal. By providing the support structure 6, each optical element can be stably arranged in the lighting optical device, and thus it is possible to achieve highly accurate focus control without being affected by external factors other than changes in ambient temperature. In addition, the support structure 6 is configured using a low expansion metal, and thus it is possible to further improve focus performance when the temperature changes.
(vii) The lighting optical device according to the first embodiment includes the control unit 8 that variably controls the focal length of the condensing optical system 5 by moving the optical elements of the condensing optical system 5 on the optical axis, and adjusts an aspect ratio of a beam spot emitted to a target (assuming that the configuration requirements of (i) are provided). Thereby, it is possible to implement a lighting optical system that controls an aspect ratio of a beam spot on an inspection target and curbs a focus shift when the ambient temperature changes.
(viii) In the second embodiment, an optical element (anamorphic prism 28) that changes an aspect ratio of a beam spot emitted on an inspection target is provided. Thereby, it is possible to easily generate a linear (elliptical) beam.
(ix) The lighting optical device according to this embodiment can be applied to a substrate inspection device. Thereby, highly accurate focus control can be performed without being affected by changes in ambient temperature, and thus it is possible to inspect a substrate (inspection target) with high accuracy.

### REFERENCE SIGNS LIST

1, 21: DUV light source
2, 22: attenuator
3, 23: mirror
4, 24: beam diameter variable unit
4a: positive lens group
4b: negative lens group
4c: positive lens group
5, 25: condensing optical system
5a, 5b: cylindrical lens
5c, 5d, 25a, 25b: mirror
5e: cylindrical parabolic mirror
6, 26: support structure
6a: base
6b_1: element support member 1
6b_2: element support member 2
6b_3: element support member 3
6b_4: element support member 4
7, 27: inspection target
8, 29: control unit
25c, 25d: spherical lens
28: anamorphic prism
100: substrate inspection device
111: stage
112: light receiving lens
113: light receiving element
114: analysis unit

1. A lighting optical device that expands a luminous flux and condenses it on a target, the lighting optical device comprising:
a light source that emits the luminous flux;
a luminous flux diameter variable unit that expands a diameter of the luminous flux emitted from the light source; and
a condensing optical system that condenses the luminous flux having the expanded diameter on the target, wherein
the luminous flux diameter variable unit includes at least four lenses,
at least one lens of the luminous flux diameter variable unit satisfies Conditional Expression (1),
at least one lens of the luminous flux diameter variable unit other than the lens satisfying Conditional Expression (1) satisfies Conditional Expression (2),
the condensing optical system includes at least two lenses,
at least two lenses of the condensing optical system satisfy Conditional Expression (3),
at least one lens of the condensing optical system satisfies Conditional Expression (1), and
at least one lens of the condensing optical system other than the lens satisfying Conditional Expression (1) satisfies Conditional Expression (2).
$$dn / dt < 0 \qquad ( 1 )$$
$$dn / dt > 0 \qquad ( 2 )$$
$$\vert \begin{matrix}{\sum }_{i = 1}^{m} ( {f}_{i} * \frac{d {n}_{i}}{dt} ) \vert < \vert f * \frac{MAX\_dn}{dt} \vert & ( 3 ) )\end{matrix}$$
Here, dn/dt represents a temperature coefficient of a refractive index, m represents the number of lenses provided in the condensing optical system, fi represents a focal length of an i-th lens in the condensing optical system, dnᵢ/dt represents a refractive index temperature coefficient of the i-th lens in the condensing optical system, f represents a focal length of the condensing optical system, and MAX_dnᵢ/dt represents a maximum value of absolute values of the refractive index temperature coefficients of the lenses provided in the condensing optical system.

2. The lighting optical device according to claim 1, wherein the light source is a light source that emits linear light.

3. The lighting optical device according to claim 1, wherein the condensing optical system satisfies Conditional Expression (4).
DR<DR_max/10 (4)
Here, DR represents an interval between two lenses provided in the condensing optical system, and DR_max represents a largest interval between optical elements among the intervals between the optical elements provided in the condensing optical system.

4. The lighting optical device according to claim 1, wherein two lenses provided in the condensing optical system are cylindrical lenses arranged such that their power directions face each other.

5. The lighting optical device according to claim 1, wherein a lens provided in the luminous flux diameter variable unit and the condensing optical system and satisfying Conditional Expressions (1) and (2) further satisfies Conditional Expression (5).

|f_max|−|f_min|<50 mm (5)
Here, f_max represents a focal length of a lens with the longest focal length among the lenses, and f_max represents a focal length of a lens with the shortest focal length among the lenses.

6. The lighting optical device according to claim 1, wherein the light source emits light in a wavelength range of 200 to 300 nm.

7. The lighting optical device according to claim 1, wherein at least one lens satisfying Conditional Expression (1) and at least one lens satisfying Conditional Expression (2), which are provided in the luminous flux diameter variable unit, are formed of the same glass material.

8. The lighting optical device according to claim 1, further comprising a control unit that moves at least one lens provided in the luminous flux diameter variable unit in an optical axis direction,
wherein the control unit changes a luminous flux diameter and controls a beam diameter by moving at least one lens provided in the luminous flux diameter variable unit in the optical axis direction.

9. The lighting optical device according to claim 1, further comprising a support structure that holds at least the luminous flux diameter variable unit and the condensing optical system,
wherein the support structure is formed of a low expansion metal.

10. The lighting optical device according to claim 1, further comprising a control unit that variably controls a focal length of the condensing optical system by moving optical elements of the condensing optical system on an optical axis, and adjusts an aspect ratio of a beam spot emitted to the target.

11. The lighting optical device according to claim 1, further comprising an optical element that changes an aspect ratio of a beam spot emitted to the target.

12. An inspection device comprising:
the lighting optical device according to claim 1;
a light receiving lens that condenses a part of diffused and reflected light generated when light from the lighting optical device hits the target;
a light receiving element that converts the light condensed by the light receiving lens into an electrical signal;
an analysis unit that analyzes the electrical signal; and
an output unit that outputs an analysis result obtained by the analysis unit.
